(19) United States
(12) Patent Application Publication
(10) Pub. No.: US 2006/0107576 A1
(43) Pub. Date: May 25, 2006

(54) Produce label with folded tab-lift and method of and apparatus for making same

(76) Inventor: Richard John Hirst, Norfolk (GB)

Correspondence Address: Bruce H. Johnsonbaugh;Eckhoff & Hoppe, Suite 2800, 101 Montgomery Street, San Francisco, CA, 94104, US

(21) Appl. No.: 11/254,275

(22) Filed: Oct. 20, 2005

Related U.S. Application Data
(60) Provisional application No. 60/620,954, filed on Oct. 21, 2004.

(51) Int. Cl. G09F 3/10

(52) U.S. Cl. 40/638

(57) ABSTRACT

A label applied to produce is provided with a novel folded tab-lift allowing the consumer to easily remove the label. The folded tab-lift is twice as thick as the body of the label and has upper and lower surfaces free of adhesive. An apparatus and method are also provided for automatically forming the novel folded tab-lifts on an array of produce labels. A drum rotating about a first axis carries one or more resilient bands that rotate with the drum. One or more elongated label tapes with exposed label heads are drawn over a portion of the drum and, as each label tape approaches the surface of the drum, it contacts a resilient band and the exposed head of each label is partially folded through approximately 90°. Each resilient band thereafter moves against a rotating folding roller which momentarily compresses and deforms the resilient band to fully fold the head portion of each label as the label moves past the folding roller.

### CROSS-REFERENCE TO RELATED APPLICATION

This application claims the benefit of and priority from U.S. provisional application Ser. No. 60/620,954 filed on Oct. 21, 2004.

### BACKGROUND AND BRIEF SUMMARY OF INVENTION

The present invention relates to labels automatically applied to produce. More particularly, the invention provides a label with a novel folded tab-lift which allows the consumer to more easily remove the label from the produce than is the case with prior art labels. The invention also provides a method of and apparatus for automatically making the novel folded tab-lifts.

Prior art produce labels include small regions of the label which are treated to not adhere to the produce. The purpose of those regions is to allow the consumer to readily remove the label. Such prior art labels inherently include a number of problems, all of which are overcome by the present invention.

First, prior art labels are typically formed by covering the entire lower surface of the label with adhesive, and then neutralizing a small region of the adhesive. The neutralizing step itself adds cost and extra steps in making the label. Those neutralizing agents are not 100% effective in that some treated areas remain somewhat adhesive and/or adhesive in treated areas over time migrates through the neutralizing agent and renders the treated region tacky. Neutralizing agents in powder form are abrasive, often become electrostatically charged making application to tabs difficult, and can cause increased wear to print heads and other related processing equipment.

Secondly, prior art labels have a generally uniform thickness over the entire label. The uniform thickness often requires the consumer to take time to locate and grasp the release region of the label, particularly if the release region is tacky.

The present invention overcomes the above problems by folding over an end portion of the label to create a tab-lift having a noticeably greater thickness than the body of the label. The thickness of the tab-lift is approximately twice that of the label body, and can be located easily and immediately by the consumer. It is also easily located in the dark or in reduced light and by sight impaired persons. Furthermore, the folded tab-lift eliminates the prior art step of applying neutralizing agents, and the attendant problems described above. The folded tab-lift has upper and lower surfaces free of adhesive material.

The invention also provides a novel apparatus and method for automatically folding labels to achieve the folded tab-lift. The novel method and apparatus avoids the use of cumbersome and complex prior art folding mechanisms. For example, U.S. Pat. No. 5,046,710 utilizes a complex arrangement of multiple folding rollers, deflectors and paper stops (shown best in FIG. 11 of U.S. Pat. No. 5,046,710) to fold leaflets. The present invention utilizes a rotating drum and a folding roller to create the folded tab-lift and avoids the cumbersome mechanism of U.S. Pat. No. 5,046,710. The prior art also includes mechanisms for incorporating previously and separately folded leaflets into labeling systems for pharmaceuticals as shown in U.S. Pat. No. 6,669,804. In contrast, the present invention creates the folded tab-lift “on the fly” and continuously as the labels are produced.

The prior art includes labels having multi-layer grip tabs that can be grasped while the user is wearing sterile plastic medical gloves, as shown in Seidl et al US 2005/0058812 A1, dated Mar. 17, 2005. The Seidl grip tab is used to label pharmaceuticals. Seidl does not form the grip tab by folding over the label body, does not teach a label suitable for use on produce, and does not teach how to continuously form multiple labels.

Most significantly, the prior art is devoid of any method or apparatus for automatically creating a folded tab-lift for use on automatically applied produce labels.

The present invention provides a method and apparatus for continuously folding the exposed head portions of labels. A resilient band carried by and rotating with a drum contacts each exposed label head and partially folds the head approximately 90° as the label tape is fed over a portion of the drum. The resilient band is then compressed and momentarily deformed by a continuously rotating folding roller. As the resilient band is deformed, it folds the label head to a fully-folded position approximately 180° from its starting position. The fully folded label head is a double thickness tab-lift with no adhesive on either its upper or lower surface. The novel tab-lift will not become tacky, is easily grasped by the consumer and avoids the use of neutralizing agents.

A primary object of the invention is to provide a fully folded tab-lift for produce labels which has upper and lower surfaces free of adhesive, does not become tacky and is quickly and easily grasped by consumers.

A further object is to provide a tab-lift for produce labels having a thickness greater than the label body to allow consumers to locate the tab-lift by touch.

A further object of the invention is to provide a tab-lift for produce labels usable in reduced lighting and usable by sight impaired persons.

A further object of the invention is to provide a method and apparatus for forming labels with tab-lifts which avoids the use of neutralizing agents.

A further object of the invention is to provide a method and apparatus for forming labels which performs the folding step continuously and which avoids the use of intermittent operating folding apparatus.

Another object of the invention is to provide a method and apparatus for automatically and simultaneously forming folded tab-lifts on two rows of labels.

Other objects and advantages will become apparent from the following description and drawings wherein:

### BRIEF DESCRIPTION OF DRAWINGS

FIG. 1 is a plan view of a prior art label tape;

FIG. 2 is a section on the line 2-2 of FIG. 1;

FIG. 3 is a plan view of a label tape according to the present invention before the label heads have been folded;

FIG. 4 is a plan view of a label tape according to the present invention after the label heads have been folded;

FIG. 5 is a section on the line 5-5 of FIG. 4;

FIG. 6 is a perspective of the apparatus for folding the label heads to form the novel tab-lifts;

FIGS. 7-10 are schematic representations illustrating four stages of the method of folding the label heads to form the novel tab-lifts of the invention, and are each described briefly below;

FIG. 7 illustrates the label tape as it is being fed toward the rotating drum carrying the resilient band;

FIG. 8 illustrates a label head being partially folded by contacting the resilient band as the label tape contacts the rotating drum;

FIG. 9 illustrates how the resilient band is momentarily deformed by the folding roller and fully folds the label head as it is deformed;

FIG. 10 illustrates the fully-folded label head and how the resilient band returns to its normal shape after it has been momentarily deformed;

FIG. 11 is a plan view of an alternate label tape in accordance with the invention wherein two rows of labels are adapted to be carried to two folding stations;

FIG. 12 is a perspective view of an alternate embodiment of the invention;

FIGS. 13-18 are schematic illustrations showing the sequential steps of the label head folding performed by the apparatus of FIG. 12; and

FIG. 19 is a composite schematic showing the steps of FIGS. 13-18.

### DETAILED DESCRIPTION OF THE DRAWINGS

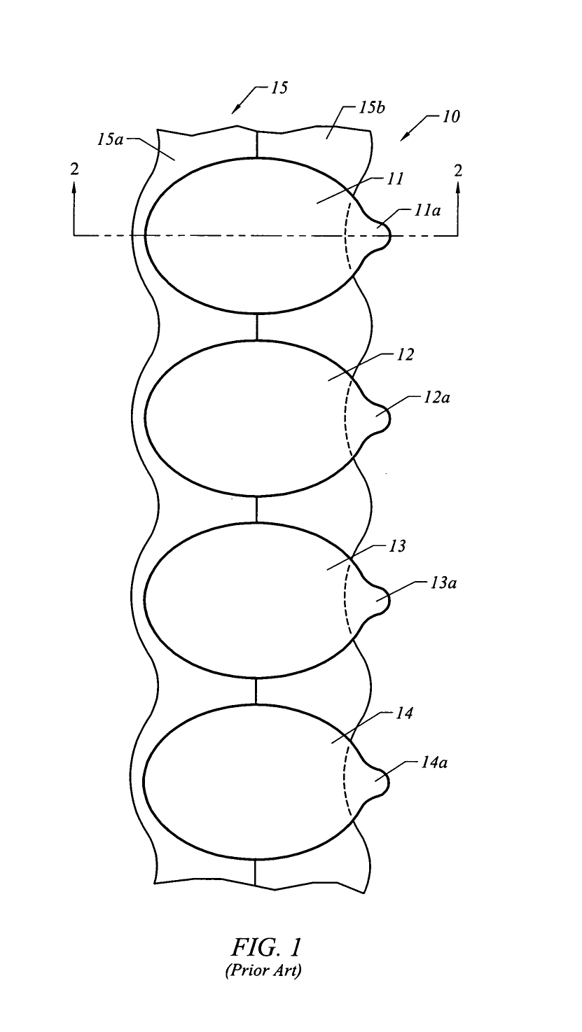

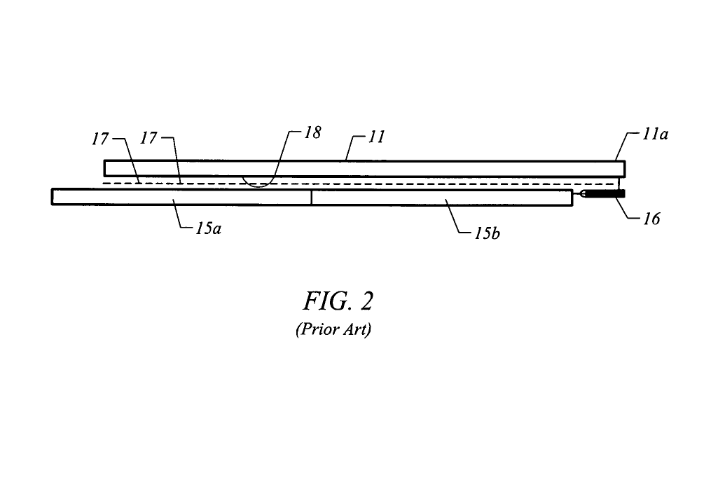

FIGS. 1 and 2 illustrate a typical prior art label tape generally as 10. Four individual produce labels 11-14 are each generally elliptical in shape and have protrusions 11a-14a which are ultimately used by consumers of the produce to pull the labels 11-14 off the produce before it is eaten. Labels 11-14 are carried by release liner 15 that comprises two elongated segments 15a and 15b as known in the art. The entire lower surfaces (not visible in FIG. 1) of labels 11-14 are coated with adhesive including protrusions 11a-14a. As noted above, the prior art labels shown in FIGS. 1 and 2 require that a neutralizing agent (either powder or liquid) be applied to the lower surface of protrusions 11a-14a in an attempt to prevent protrusions 11a-14a from adhering to the produce. The neutralizing agent 16 is shown in FIG. 2 below protrusion 11a. The layer of adhesive 17 is shown in FIG. 2 applied to lower surface 18 of label 11.

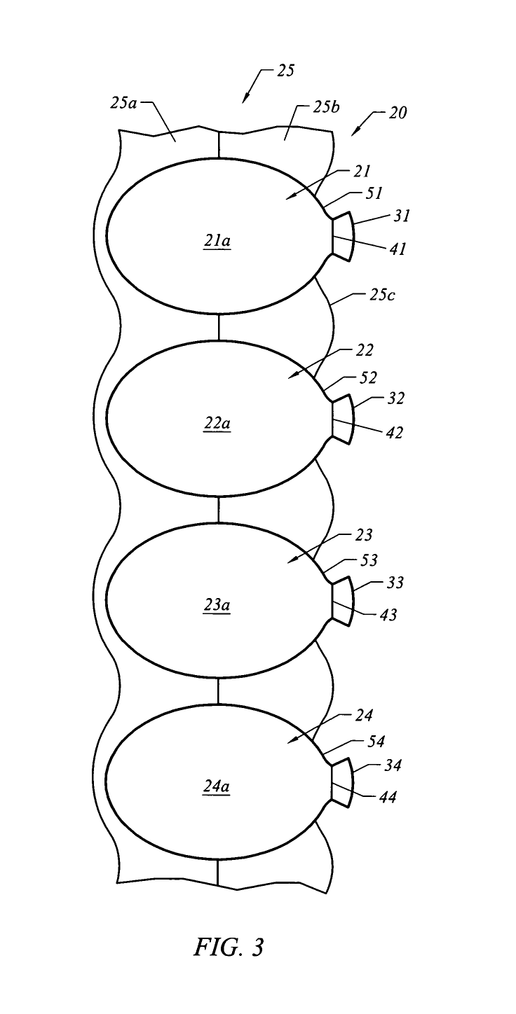

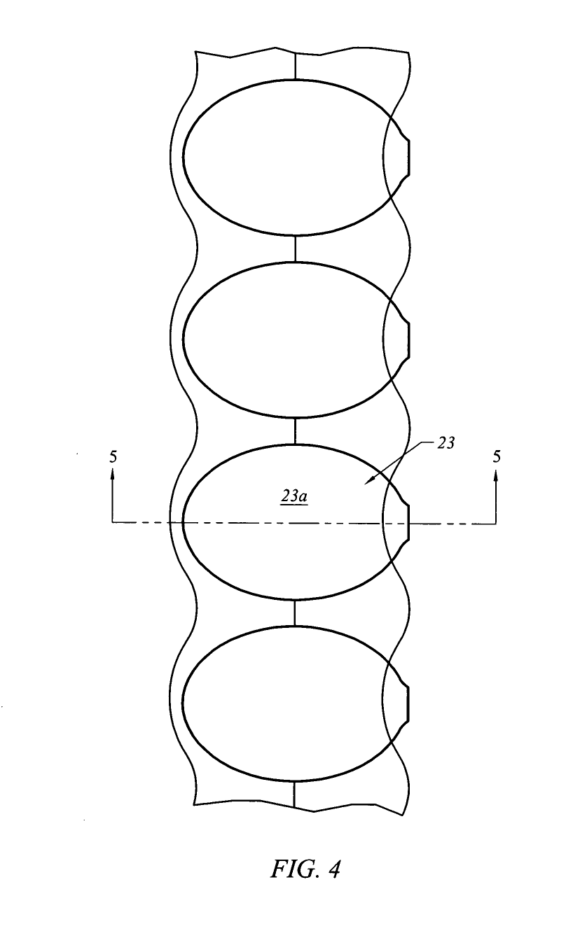

FIGS. 3 and 4 illustrate a label tape 20 carrying labels 21-24 according to the present invention. The phrase “label tape” includes the release liners 25a,25b, the labels 21-24 and the adhesive backing. Labels 21-24 have generally elliptically shaped bodies 21a-24a and integrally formed head portions 31-34, respectively, and neck portions 51-54, respectively. Neck portions 51-54 each have a width narrower than respective head portions 31-34. Head portions 31-34 are referred to herein as “label heads” and extend transversely (in the plane of the label body) beyond the outer edge 25c of release liner 25b. The labels are preferably made of plastic sheet material having a generally uniform thickness.

In the preferred embodiment, fold lines 41-44 are formed in the upper surface of labels 21-24, respectively, to allow head portions 31-34 to be more easily folded in a direction downwardly from the plane of the sheet of FIG. 3. Labels 21-24 are carried by release liner 25 having two separate elongated segments 25a and 25b as is known in the art.

FIG. 4 illustrates labels 21-24 of FIG. 3 after the head portions 31-34 have been folded downwardly as viewed in FIG. 4 and fully folded through approximately 180° against the lower surface of labels 21-24. Release liner 25b is formed with generally serpentine or wavy-shaped edges to allow the head portions 31-34 to be folded backwardly against the back surface of labels 21-24 without contacting the release liner. The resulting upper and lower surfaces of the folded tab-lifts are free of adhesive. In addition, the folded tab-lifts are approximately twice as thick as the body portions 21a-24a. The folded tab-lifts, therefore, do not adhere to the produce and are easily located so that the consumer can readily use the exposed head portion as a tab-lift to remove the labels from the produce.

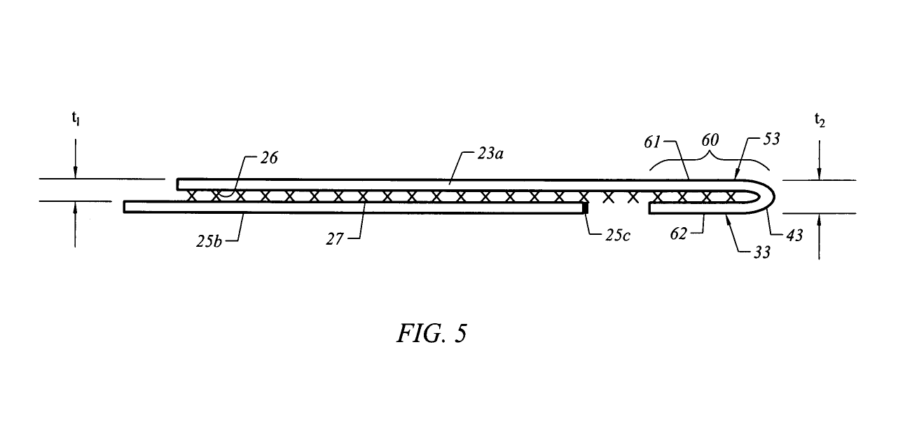

FIG. 5 is a sectional view of label 23 after its head 33 has been fully folded approximately 180° relative to body portion 23a. The thickness t₂ of folded tab-lift shown generally as 60 is approximately twice the thickness t₁ of the body 23a of label 23. The upper surface 61 and lower surface 62 of tab-lift 60 are each free of adhesive. The two layers 33 and 53 forming the tab-lift are held together by adhesive backing.

Adhesive backing 27 covers the entire lower surface 26 of label body 23a and label head 33. Label head 33 is therefore adhesively connected to the neck 53 of label 23 after it is folded to the fully folded position shown in FIG. 5.

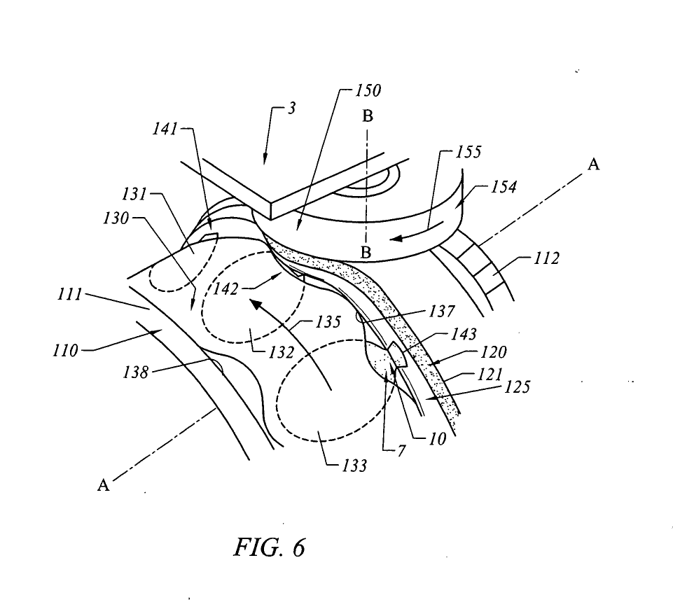

FIG. 6 is a perspective view of the critical components of the apparatus utilized to form the folded tab lift of the present invention. A drum 110 is provided which rotates around a first axis A-A. Axis A-A is preferably horizontal. Drum 110 has flanges 111 and 112 formed at each end thereof.

A resilient band 120 is carried by drum 110 and extends circumferentially around drum 110 and rotates with the drum. Resilient band 120 is preferably made of silicon sponge rubber or other resilient and deformable material. The preferred form of resilient band 120 includes a side wall forming a vertically extending flange 125. The purpose of the silicon sponge rubber flange 125 is to contact the head portions of the labels and continuously fold them as described below in detail.

An elongated label tape 130 carries an array of labels having body portions 131, 132 and 133 which are shown in phantom, since label tape 130 is inverted in FIG. 6 from the label tape orientations shown in FIGS. 3-5. Label tape 130 is fed over a portion of the surface of drum 110 by a label feed means which causes the label tape 130 to contact drum 110 and to move with drum 110 at the same speed in the direction of arrow 135 as drum 110 rotates in a counterclockwise direction around axis A-A as viewed in FIG. 6. Label tape 130 is tensioned by rollers upstream and downstream of drum 110 by tensioning rollers known in the art. Label tape 130 is fed onto drum 110 with the exposed label head portions such as 143 adjacent the silicon sponge rubber flange 125 of resilient band 120. The exposed head portion 143 of label 133 is contacted by the silicon sponge rubber flange 125 and is partially folded to approximately a 90° angle as label 133 approaches contact with drum 110.

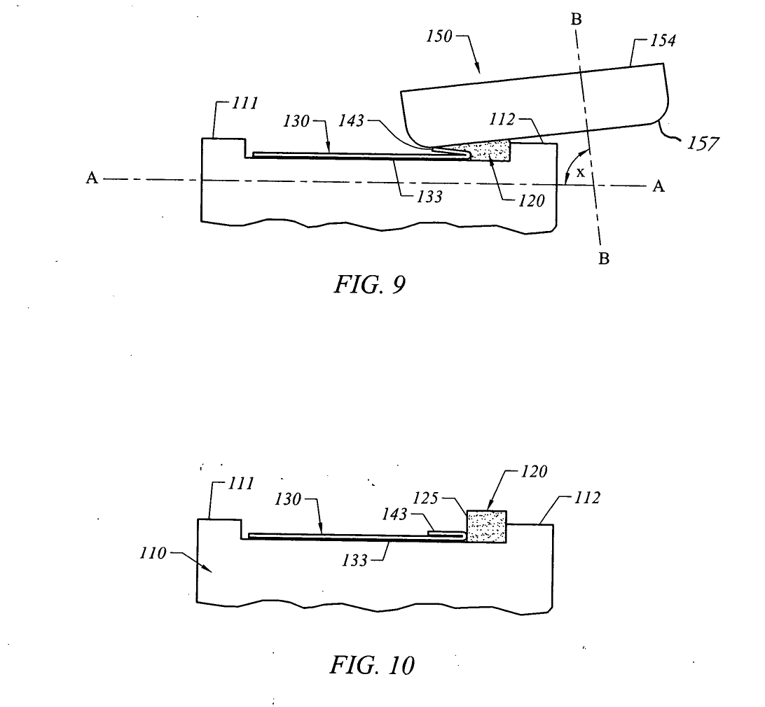

Folding roller means 150 includes a profiled folding roller 154 mounted for powered rotation about axis B-B in a generally clockwise direction as viewed in FIG. 6 and as shown by directional arrow 155. Folding roller 154 has a profiled lower surface 157 having a convex surface shaped to deform resilient band 120 to continuously and fully fold the label heads. The axis of rotation B-B of folding roller 154 is inclined from the vertical (see FIG. 9) in order to progressively and momentarily deform resilient band 120 sufficiently to fold the label heads fully to a position 180° from their starting positions. As shown best in FIG. 9, axis B-B is inclined relative to axis A-A at angle X in order to maximize the momentary compression and deformation of resilient band 120 achieved by folding roller 154 to fully-fold the label heads by flattening them against the respective neck portions as noted above. Angle X is preferably in the range of 75° to 85°.

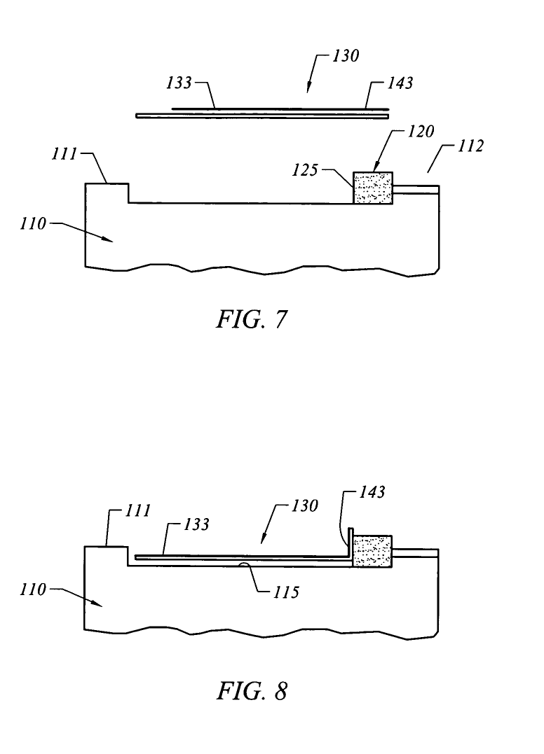

FIGS. 7-10 illustrate the method of folding the label heads by referring to components shown in FIG. 6. For convenience, a single line is used to denote the label tape 130

FIG. 7 shows label tape 130 as it approaches drum 110 and before the head 143 contacts resilient band 120.

FIG. 8 illustrates how resilient band 120 partially folds label head 143 approximately 90° as label tape 130 contacts the surface 115 of drum 110. The downward motion of label tape 130 relative to resilient band 120 causes head 143 to be partially folded (as shown also at 143 in FIG. 6).

FIG. 9 shows how, as label tape 130 rotates with drum 110 and contacts folding roller 154, resilient band 120 is compressed and deformed by folding roller 154, causing the flange 125 of band 120 to deform from its generally vertical orientation in FIG. 7 to a generally horizontal orientation, parallel to the top surface of drum 110. This momentary deformation of resilient band 120 fully folds label head 143 to a position parallel to the label body and 180° from the starting position of label head 143 shown in FIG. 7.

FIG. 10 illustrates label 133 with fully folded label head 143 after it rotates with drum 110 past folding roller 150. Resilient band returns to its normal state with flange or side wall 125 in a vertical orientation. Label 133 is thereafter fed with label tape 130 onto a label reel and is ready to be automatically applied to produce.

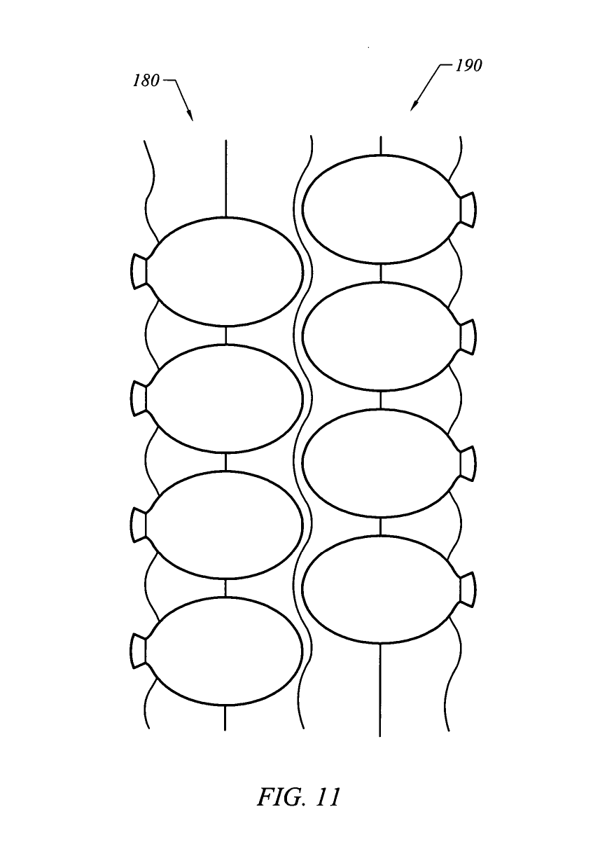

FIG. 11 illustrates a pair of label tapes 180 and 190 with label heads extending outwardly which can be fed onto a wider drum (not shown) having two folding rollers, one folding roller at each end of the wider drum.

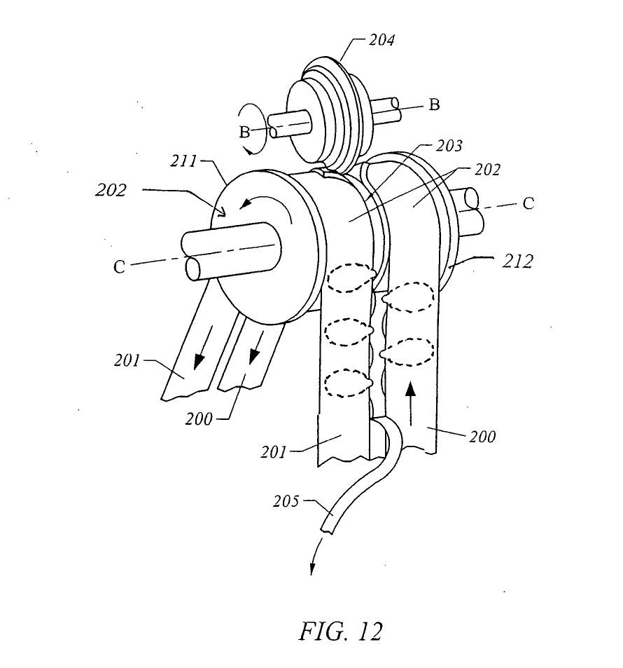

FIGS. 12-19 illustrate an alternate, and preferred, form of the invention wherein first and second rows of labels 200 and 201 with label heads extending inwardly are simultaneously presented to a folding system and two rows of labels are simultaneously folded. The pair of label tapes 200 and 201 are fed onto a wider drum 202 having flanges 211 and 212. Drum 202 carries a split folding element 203 comprising first and second resilient bands 203a and 203b made of resilient material which comprises first and second raised ridges, or resilient bands, 203a and 203b. Each ridge or band contacts a row of label heads and folds them through approximately a 90° angle. As the tapes 200 and 201 are pulled over rotating drum 202, a folding roller 204 contacts and deforms the two ridges 203a and 203b of resilient split folding element 203 and folds the tabs from approximately a 90° angle to approximately a 180° angle from the starting position of the exposed heads. The folding roller 204 is a single roller (or a pair of rollers) rotating on an axis B-B which is parallel to the axis of rotation C-C of drum 202. The folding roller 204 acts in similar fashion to the folding roller 154, described above, to fully fold each label head as the folding roller 204 deforms folding element 203 and causes the label to fold fully. Once the label head has passed the folding roller 204, the label head is fully folded and the folding roller continues to rotate to fold oncoming and partially folded label heads. The motion of the folding mechanism of FIG. 12 is continuous as opposed to intermittent and is capable of folding labels on two label tapes simultaneously. The tapes 200 and 201 are fed towards the drum 202 as a single piece joined at the center until a center portion of the carrying strip 205 is drawn away to expose the label heads just prior to the tapes entering onto the drum 202. In this way, the tabs on both label tapes 200 and 201 have the adhesive backed head portions exposed just prior to entering drum 202 and both tapes have the label heads folded in one operation at the center of the drum 202.

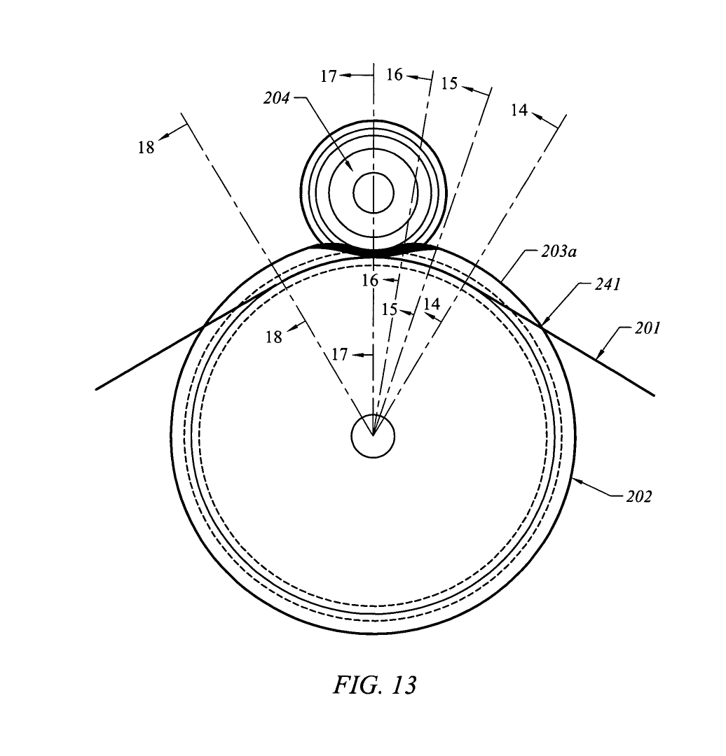

FIGS. 13-18 are schematic representations showing the sequential steps of operation of the system shown in FIG. 12. FIG. 19 is a composite of FIGS. 13-18.

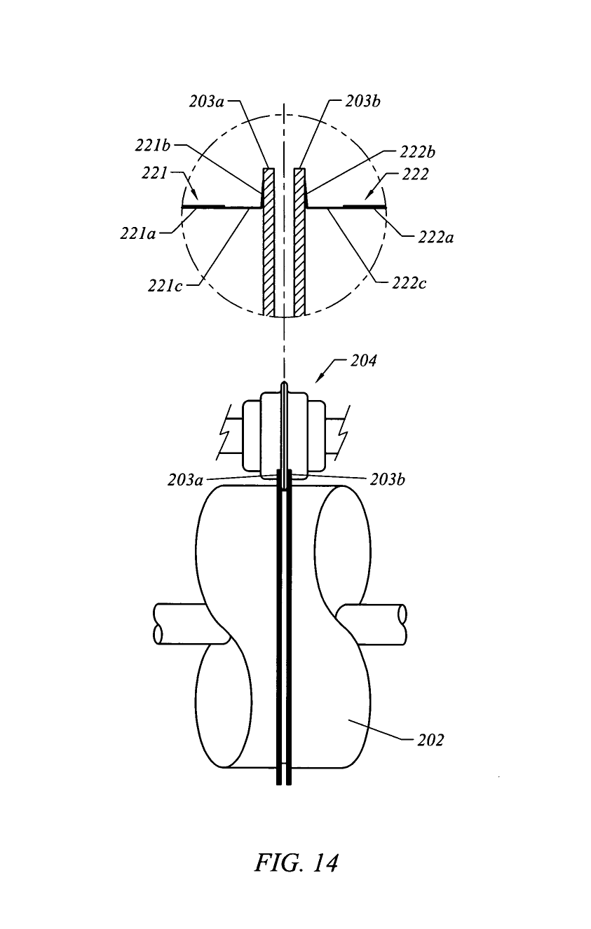

FIG. 13 is a side sectional view of drum 202 and folding roller 204. Incoming label tape 201 is shown being drawn across drum 202 as drum 202 rotates. FIGS. 14-18 are sectional views on the sectional lines of FIG. 13 and illustrate the sequential steps of the folding operation. The first step occurs as label tape 201 makes contact with resilient band 203a at contact point 241. FIG. 14 shows how each label head is bent through 90° as the label head moves from contact point 241 to section line 14-14, at which point label tape 201 is adjacent to and in contact with the surface of drum 202.

FIG. 14 illustrates labels 221 and 222 as label tapes 200 and 201 (FIG. 12) contact the surface of drum 202. The label heads 221b, 222b have been partially folded through approximately 90° by contacting and moving downwardly against first and second resilient bands or ridges 203a, 203b, respectively. The label necks 221c, 222c remain horizontal with the release liner removed. The label bodies are 221a and 222a. Label bodies 221a and 222a are carried by release liners 221d and 222d.

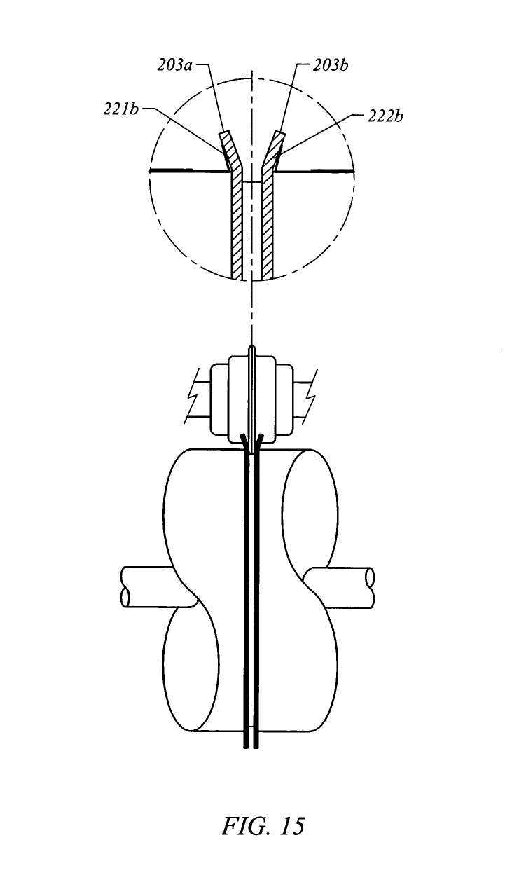

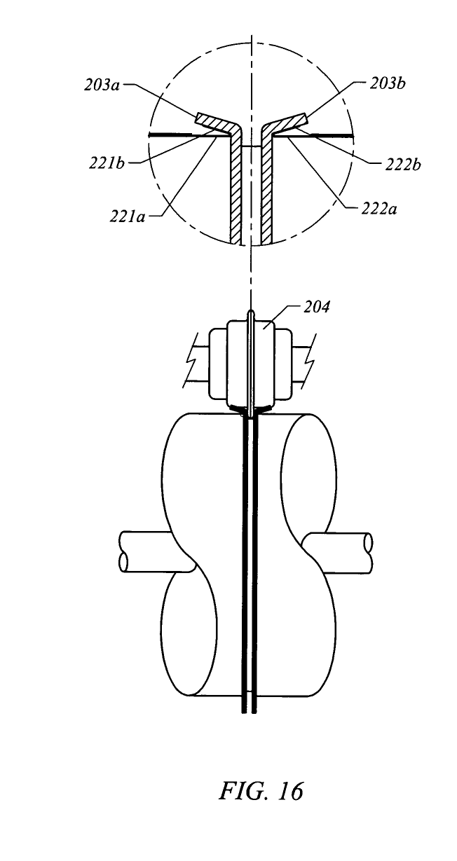

In FIG. 15, folding roller 204 located between first and second bands has begun spreading resilient bands or ridges 203a, 203b and label heads 221b, 222b are folded through an angle larger than 90°. FIG. 16 shows a continuation of the folding as folding roller 204 further deforms resilient bands or ridges 203a, 203b to nearly flatten label heads 221b and 222b against label necks 221a and 222a, respectively.

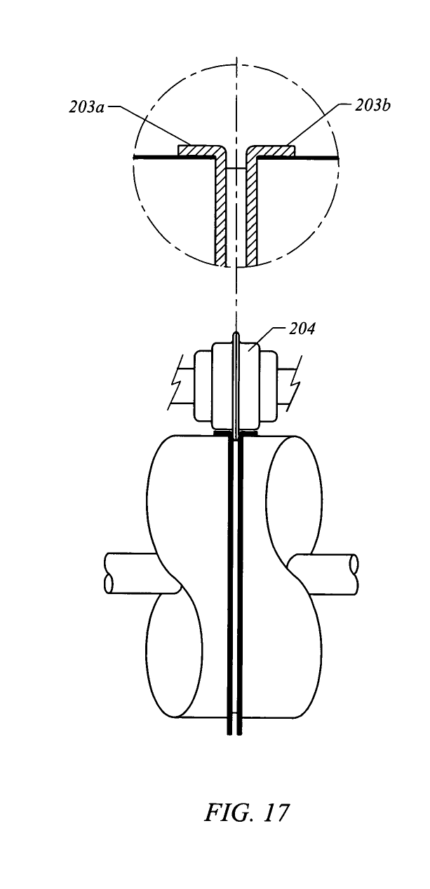

FIG. 17 shows the point of maximum deformation of resilient bands or ridges 203a, 203b by folding roller 204 wherein label heads 221b, 222b have been fully folded through approximately 180° and are in full contact with label necks 221a, 222a.

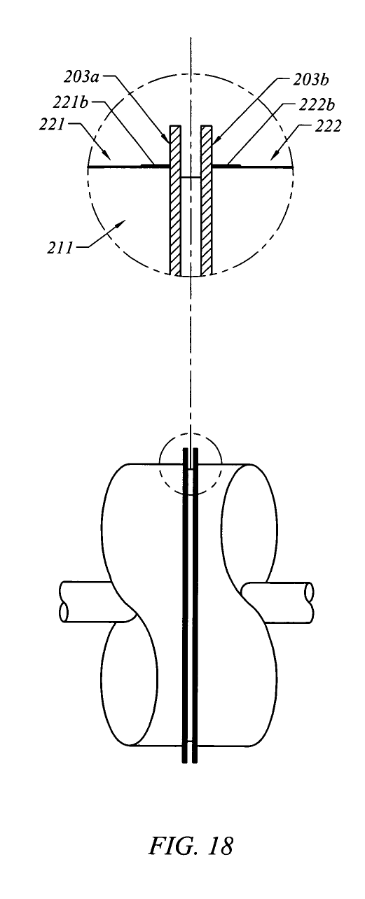

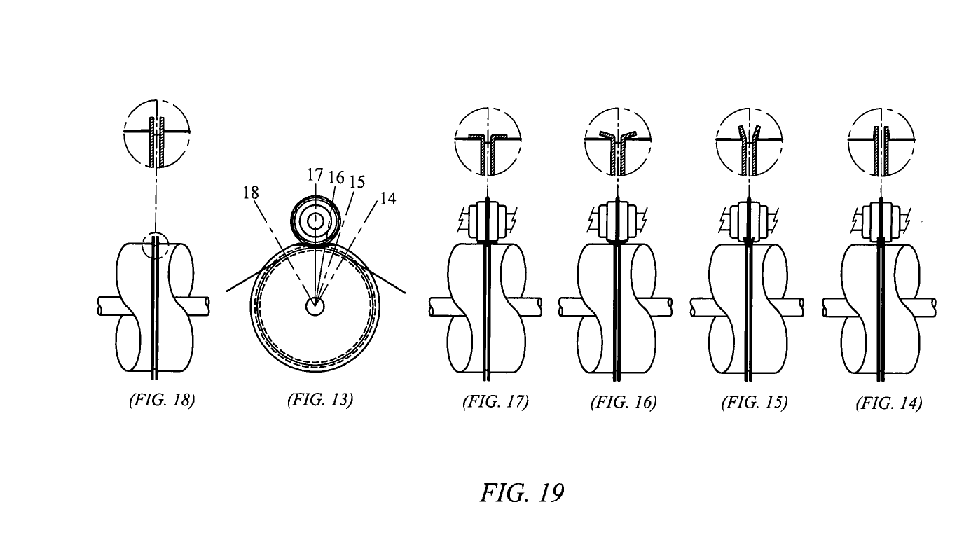

FIG. 18 shows fully folded labels 221, 222 after the labels have moved beyond folding roller 204. Resilient bands or ridges have returned to their upright and parallel configuration.

FIG. 19 is a composite including the subject matter of FIGS. 13-18 to show the sequential steps described above.

The foregoing description of the invention has been presented for purposes of illustration and description and is not intended to be exhaustive or to limit the invention to the precise form disclosed. Modifications and variations of the above are possible in light of the above teaching. These particular embodiments were chosen and described to best explain the principles of the invention and its practical application, thereby enabling others skilled in the art to best use the invention in various embodiments and with various modifications suited to the particular use contemplated. The scope of the invention is to be defined by the following claims.

What is claimed is:

1. A label adapted to be applied to produce and which is easily removed from said produce comprising:
a body formed of sheet material having an upper surface and a lower surface, said sheet material having a generally uniform thickness,
an adhesive layer carried by said lower surface of said body,
a head portion integrally connected to said body and formed of said sheet material,
said head portion including a folded tab-lift including a folded and double thickness of said sheet material, said folded tab-lift having upper and lower surfaces free of adhesive material.

2. The label of claim 1 wherein said folded tab-lift includes adhesive between said double thickness of said sheet material.

3. The label of claim 1 further comprising a neck portion of sheet material between said body and said head portion, said neck portion having a narrower width than the width of said head portion.

4. The label of claim 1 wherein said sheet material is plastic.

5. A label tape carrying a plurality of labels adapted to be automatically applied to produce items, comprising:
a release liner,
a plurality of labels, carried by said release liner,
an adhesive backing carried by each of said labels,
each of said labels having a body formed of sheet material having a generally uniform thickness, and each label having a head portion including a folded tab-lift formed by a folded, double thickness of said sheet material.

6. The label tape of claim 5 wherein said release liner has a serpentine shape to allow said head portion to be folded to form said folded tab-lift, without contacting said release liner.

7. The label tape of claim 6 wherein said release liner comprises two separate elongated segments.

8. A dual label tape carrying first and second rows of labels adapted to be automatically applied to produce items, comprising:
first and second release liners,
first and second rows of labels, carried by said first and second release liners, respectively,
an adhesive backing carried by each of said labels,
each of said labels having a body formed of sheet material having a generally uniform thickness, and each label having a head portion adapted to be folded into a folded tab-lift having a folded, double thickness of said sheet material, and
a third release liner carried between said first and second release liners, said third release liner forming a backing for said head portions of said first and second pluralities of labels, said third release liner being removable to expose said head portions to facilitate automatic folding of said head portions.

9. The dual label tape of claim 8 wherein said first and second release liners have a serpentine shape to allow said head portions to be folded to form said folded tab-lift, without contacting said release liner.

10. The dual label tape of claim 8 wherein each of said first and second release liners comprises two separate elongated segments.

11. Apparatus for automatically forming folded tab-lifts on an array of produce labels, wherein said array of labels is carried on an elongated release liner and wherein each label has a head portion that extends transversely beyond the edge of said release liner, comprising:
a drum mounted for rotation about a first axis,
a resilient band carried by and rotating with said drum,
label feed means for applying tension to said elongated release liner and for feeding said tensioned release liner over a portion of said drum and for positioning said release liner parallel with and sufficiently close to said resilient band to partially fold said head portion of each label as said head portion contacts said resilient band, and
folding roller means for momentarily compressing and deforming said resilient band to fully fold said head portion of each label as each label moves past said folding roller means.

12. The apparatus of claim 11 wherein said folding roller means comprises a roller with a convex lower surface shaped to deform said resilient band.

13. The apparatus of claim 12 wherein said roller rotates about a second axis inclined at an angle of between 75° and 85° relative to said first axis.

14. The apparatus of claim 11 wherein said array of labels comprises first and second rows of labels, and said first and second rows of labels are folded simultaneously, said folding roller means comprises a roller rotating about a second axis parallel to said first axis, and said drum carries first and second resilient bands, and wherein said folding roller is located between said first and second resilient bands and said folding roller momentarily spreads said first and second resilient bands apart to form said folded tab-lifts.

15. A method for automatically forming folded tab-lifts on an array of produce labels wherein each label has a body portion carried on an elongated release liner and a head portion extending transversely beyond the edge of said release liner, comprising the steps:
passing an elongated release liner carrying an array of produce labels over a rotating drum with said head portions extending transversely beyond the edge of said release liner,
tensioning said elongated release liner,
contacting said head portions with a resilient band carried by and rotating with said drum and partially folding said head portion relative to said body portions of said labels,
momentarily compressing and deforming said resilient band while said resilient band remains in contact with said head portions and fully folding said head portions relative to said body portions of said labels.

16. The method of claim 15 wherein first and second release liners carrying first and second rows of labels are passed over said drum and two resilient bands are compressed and deformed simultaneously, whereby first and second rows of labels have the label heads carried thereon folded simultaneously.
